(19) United States
(12) Patent Application Publication
(10) Pub. No.: US 2013/0074362 A1
(43) Pub. Date: Mar. 28, 2013

(54) Paint Drying System

(71) Applicant: Mark Brian Lesicka, San Diego, CA (US)

(72) Inventor: Mark Brian Lesicka, San Diego, CA (US)

(21) Appl. No.: 13/245,869

(22) Filed: Sep. 27, 2011

(51) Int. Cl. F26B 21/00

(52) U.S. Cl. 34/569

(57) ABSTRACT

A system comprises a blower for moving a volume of air. A motor is operable for controlling the blower. A cooling unit is operable for cooling bearings of the blower during operation. An intake conduit is configured for passing heated air from a plenum space atop of a paint spray booth enclosure to the blower. A delivery conduit delivers the heated air to a plurality of locations within the paint spray booth enclosure. A plurality of air knifes are joined to the delivery conduit at the plurality of locations to deliver a laminar flow of the heated air into the paint spray booth. A plurality of comb devices, each joined to a one of the plurality of air knifes, are configured to disrupt the laminar flow to produce a turbulent flow in which an object within the paint spray booth enclosure is surrounded by the turbulent flow of heated air.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a paint drying system. More particularly, the invention relates to a system for drying painted motor vehicles.

### BACKGROUND OF THE INVENTION

Recently released regulations implemented by the Environment Protection Agency (EPA) have begun eliminating solvent based paints in many areas of the U.S. and have started mandating waterborne paints. The use of waterborne paints in many instances has resulted in substantially increased drying times. Furthermore, a typical result of waterborne paints is softer paint finishes located under the clear coat when proper drying has not occurred.

Prior to the new regulations, solvent based paints were typically used for automotive painting processes in the United States. Furthermore, application of waterborne paints using conventional systems has significantly increased drying time in many cases.

Conventional automobile spray-booths perform drying for solvent-borne paints which have been applied onto the surfaces of an automobile by passing heated air over the painted surface. Typically, heated air is blown down through inlets in a ceiling of the booth and is evacuated through floor outlets. This process involves the release of polluting solvents into the atmosphere while the paint is curing. In an effort to conform to new legislation which regulates the use of solvent-borne paints, paint manufacturers have developed new paints that are less damaging to the environment, such as water-borne paints.

However, in many instances, using a conventional paint drying spray-booth has resulted in increased time for drying water-borne paints. This is due to conventional systems relying on the volatility of the paint solvent to dry the paint quickly. As water is much less volatile than solvent it takes substantially longer to evaporate under normal ambient conditions. The water in water-borne paints is thereby released more slowly, resulting in extended drying times when using conventional drying systems. The drying time of water-borne paints in many cases is further increased when ambient humidity levels rise. Others have attempted to apply air directly onto the freshly painted surface of the automobile and have found that water becomes entrained in the finished surface and paint blistering occurred. This could have been a result of using too high pressure such as those producing 10 PSI or higher of air flow.

Furthermore, industrial shops that use various coatings especially epoxy based primers and paints are faced with substantially extended dry times whenever the ambient air temperature falls below 70 degrees Fahrenheit, especially in colder climates and always during winter months. Drying times for some products can increase from 20 minutes at 90-100 degrees Fahrenheit air and surface temperature to over 6 hours if the temperature decreases below 50 degrees Fahrenheit. The typical enclosure for applying these coatings is either of a downdraft or side draft configuration where airflow is laminar and typically flowing at low speeds as in the automotive industry. In commercial and industrial applications it is typical to introduce materials much thicker and heavier making it increasingly more difficult to attain proper paint application temperatures of metals and other materials using standard air flow in an enclosure.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example paint drying system, in accordance with an embodiment of the present invention;

FIG. 2 illustrates a close-up view of an example air-knife as described with reference to FIG. 1, in accordance with an embodiment of the present invention;

FIG. 3 presents a picture of an example air knife configuration as described with reference to FIGS. 1-2, in accordance with an embodiment of the present invention;

FIG. 4 presents a picture of an example of a single enclosure air delivery assembly as described with reference to FIGS. 1-2, in accordance with an embodiment of the present invention;

FIG. 5 presents a picture of an example of the multiple booth air delivery assembly as described with reference to FIGS. 1-2, in accordance with an embodiment of the present invention;

FIG. 6 presents a picture of a programmable logic relay.

FIG. 7 presents a picture of a flexible arm with shutoff valve.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art, many careful considerations and compromises typically must be made when designing for the optimal manufacture of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A first embodiment of the present invention will be described which provides means and methods for providing a paint drying system providing decreased drying time, decreased cost and increased efficiency as compared to conventional systems. Furthermore, paint drying system employs air knives with associated comb devices for converting the laminar air flow of a conventional paint spray booth enclosure to a turbulent air flow for decreasing drying time. Furthermore, paint drying system provides air flow through re-circulation of air, thereby increasing air temperature of paint drying system for realizing decreased drying time. Furthermore, paint drying system reduces relative humidity thereby realizing decreased drying time.

In other embodiments of the present invention, a method and means for providing a basic configuration of a paint drying system will be described. Basic configuration of paint drying system receives external air for generating air flow. Furthermore, basic configuration of paint drying system is configured for operation without flow control valves.

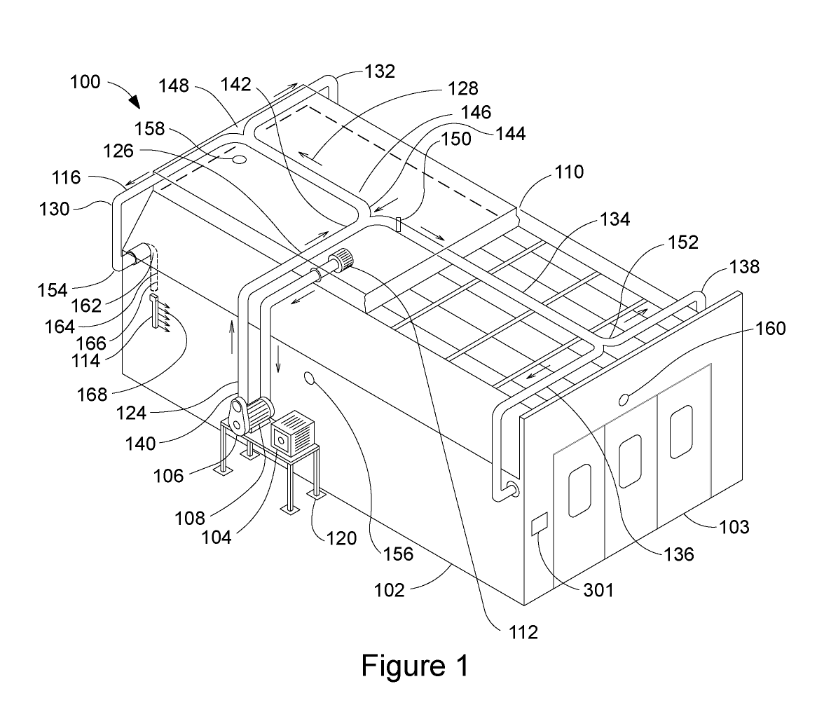

FIG. 1 illustrates an example paint drying system, in accordance with an embodiment of the present invention.

A paint drying system 100 includes an enclosure 102, a cooling unit 104, a blower 106, a motor 108, a plenum space 110, a filter 112, a multiplicity of air knifes with a sampling denoted as an air knife 114, a delivery conduit 116 and an intake conduit 118.

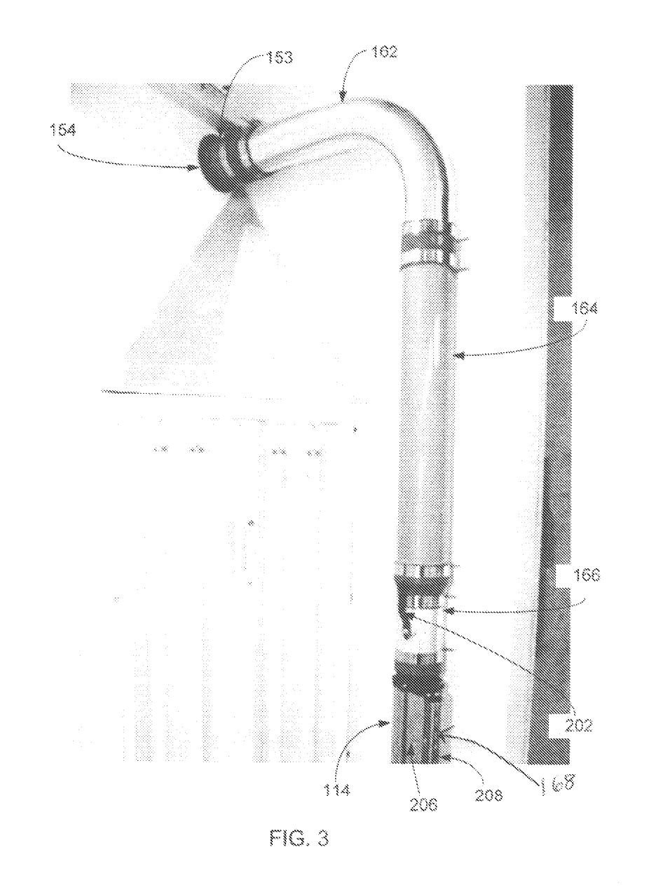

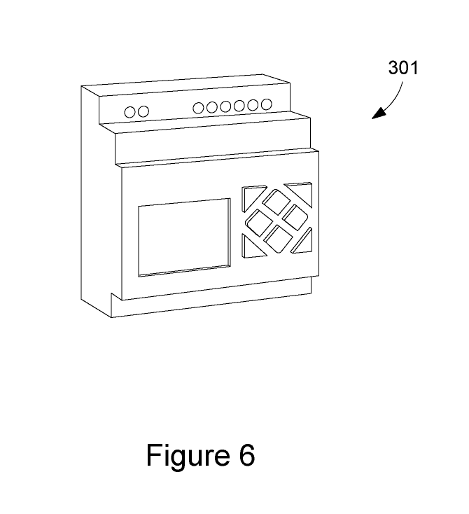

Paint drying system 100 facilitates drying of paint applied to an object (not shown) located within enclosure 102. A door 103 may be configured in side of enclosure 102 for enabling entry of items for applying drying procedure and exit of items following drying procedure. As a non-limiting example, additional adjustable air knives or flexible nozzles may be positioned above door 103 or any other place necessary for a specific drying process required by the facility for processing items of increased height, (e.g. mini-vans, trucks, etc) length, width and shape. Furthermore, additional air nozzles may be mounted via flexible anti-static arms (FIG. 3) such as, but not limited to, electro conductive acetal copolymer tubular segment arms in order to enable for adjustment of air flow from higher mounted nozzles. Typically these tubular segments are known for use in vacuum attachments that hold the vacuum in a fixed position for controlling debris from machine tools. They are available in different sizes. Furthermore, as a non-limiting example, an electronically controlled timer mechanism (Programmable Logic Relay) may be programmed for the various processes (e.g. primer drying, base coat drying, epoxy, etc.). The programmable logic relay 301 (FIG. 1 and FIG. 6) automatically controls the delay times for different paint processes which require varying lengths of time before direct air flow can be applied without damage to the fresh paint or clear coat. In a non-limiting example, primer dries quickly and needs almost no delay so the timer is set to no delay and then runs for 5 to 30 minutes (preferably 5 to 10 minutes to allow time for primer to dry completely) on the “Primer Cycle”. Base coat requires a 1 to 5 minute delay therefore timer on “Base Coat Cycle” is preferably set for 2 to 3 minutes and “Clear Coat Cycle” is set for 3 to 12 minute delay (preferably set for 6 to 8 minute delay) and runs for 10 to 40 minutes. Preferably the “Clear Coat Cycle” runs for 20 to 30 minutes. Pearl and metallic paints require a longer 8-15 minute (preferably 10 to 12 minutes) delay to avoid moving the metallic or pearl particulate in the paint finish and ruining the finish. The Metallic/Pearl cycle runs for 10 to 30 minutes, preferably 25 to 30 minutes to insure complete drying of the finish. Furthermore, as a non-limiting example, epoxy primer requires 1 to 5 minutes of delay and then runs for 15 to 60 minutes with a typical setting of 20 minutes when enclosure temperature is at 90 degrees Fahrenheit or higher. Epoxy topcoats require 5 to 10 minutes of delay with a typical setting of 10 minutes and then run for 15 minutes to 4 hours depending on brand, type and specifications of topcoat. These various timed delays allow time for the paint to cure to enough to avoid moving wet paint and damaging the finish. Furthermore, a warning mechanism may be configured for generating an alert for failures associated with coolant system in order to prevent damage to system. Furthermore, as a non-limiting example, a mechanism may be employed for notification of air filter performance and for notification of needing a filter change. Furthermore, as a non-limiting example, indicators may be configured for indicating the status of paint drying system 100 (e.g. operational, non-operational, etc.). Furthermore, as a non-limiting example, operation of paint drying system 100 may be controlled via pneumatic valves and an associated electronic timing mechanism. The programmable logic relay 301 may comprise a metallic enclosure, one selector switch with 2 positions or 3 positions maintained and 2 to 3 contactor blocks (normally closed) with timed delays on each position set. Furthermore, as a non-limiting example, a blow off nozzle or gun may be located in any area in the enclosure utilizing ionization in the nozzle or gun to blow off parts or blow off the entire vehicle prior to painting to avoid any contaminants that may be lodged on the item from becoming embedded in the finish during use of the paint drying system. Furthermore, as a non-limiting example, a variable frequency drive (VFD) may be used to further control the airflow. These devices are typically used to control motors where increased or decreased speed is important to control air flow in a ventilation system. Utilizing a VFD allows for greater control of the paint drying system via automation of controls. The VFD can be programmed to slowly increase air flow over time.

Furthermore, as a non-limiting example, an air compression variable heating system may be substituted for the standard blower 106 to allow for a heat source in the enclosure when heat is not currently available or to cut back on bake cycle gas usage and save on utility expenses. This provides variable air temperatures of up to 270 degrees at the air outlet with minimal increased utility costs. The additional blower horsepower required to generate this additional heat is comparable, and in some cases less, than the energy of a secondary, in-line heater system. In any event, the size, maintenance, and costs associated with a secondary heat system are totally eliminated. The rise in temperature is due to recirculation of the compressed air thereby superheating the air which does not require further utility costs. Furthermore, as a non-limiting example, the drying system may incorporate a housing or cover as an option. The housing or cover protects the air knife, comb and interior ducting from overspray which is common in any spray booth enclosure. The housing may be a wall mounted unit with doors that open manually or with an automated mechanism such as a pneumatic ram or similar device that would be controlled automatically when the system is activated. The housing or cover may be fabricated out of any suitable material capable of withstanding temperatures of up to 180 degrees. Furthermore, the device may incorporate a spring loaded door on a housing or mounted directly to the air knife and automatically actuated by the airflow when the drying system is activated and then closed by spring return once drying is complete and system is shut down by operator or by the automatic control system. Furthermore, the housing or cover may be manually configured as well.

As a non-limiting example, the paint drying system may be expanded for use on a multitude of enclosures using a single paint drying system 100, FIG. 1 by connecting the blower outlet 140 to a control valve 107, connected to a wye 111, connected to multiple conduits 115, connected to multiple pneumatic slide gate valves 117 and then to multiple conduits for inlet and outlet air to multiple booths (not shown) operating one booth at a time.

Non-limiting examples for applications of paint drying system 100 include automotive, commercial, aerospace, industrial, marine, woodworking, cabinet production and door fabrication and any item or product painted in an enclosure 102 or wherever large volumes of air taken from the heated plenum space 110 could be directed onto the surface of the painted item either before it is painted to raise metal or material temperature or after applying a coating in order to shorten drying times and increase production without adding additional costly enclosures that take up valuable floor space.

Enclosure 102 provides a barrier between items located within enclosure 102 and the environment external to enclosure 102.

Cooling unit 104 provides cooling of bearings located inside of the blower 106 housing by liquid circulating internally of the blower head and then back into the cooling unit. As a non-limiting example, cooling unit 104 may be configured as a closed-loop re-circulated liquid cooling unit.

Blower 106 provides a flow of air distributed within enclosure 102. As a non-limiting example, blower 106 may be configured as a centrifugal blower.

Motor 108 provides power for operation of blower 106. As a non-limiting example, motor 108 may be configured as an electric motor.

Plenum space 110 controls the pressure of the air located within enclosure 102.

Filter 112 filters incoming air for removal of particles from the air. Filter 112 receives air from internal to enclosure 102. As a non-limiting example, filter 112 may be configured for filtering particles as small as 10 microns. For basic configuration of paint drying system, filter 112 receives incoming air from external to enclosure 102.

Air knife 114 provides a high velocity stream of air to objects located within enclosure 102 in order to facilitate drying. As a non-limiting example, the length of air knife 114 may range from 3 inches to 96 inches allowing for taller vehicles such as buses, trucks and other larger painted items to be effectively dried using the system. Preferably the air knife will be 18″ in length for most average sized vehicles.

As a non-limiting example, air knife 114 may be mounted at an elevation above the floor of 24 inches to 48 inches.

Delivery conduit 116 provides a path for air to be delivered from blower 106 to air knife 114 and other associated air knives (not shown).

Intake conduit 118 provides a path for air to be delivered from filter 112 to blower 106.

Cooling unit 104 connects to blower 106 in order to provide cooling of the blower unit to avoid damage to bearings when air temperatures exceed 100 degrees Fahrenheit which is typical of most enclosures. The typical enclosure for applying and drying of coatings is set to achieve a temperature range of 90 to 180 degree Fahrenheit. Typical blower bearings cannot handle temperatures over 100 degrees for extended periods because it liquefies the lubricant on the bearings and leads to blower failure. With the liquid filled cooling unit 104, the paint drying system can reach temperatures of up to 400 degrees without failure or change in the performance of the blower system 106. Motor 108 connects to blower 106 and provides power for operation of blower 106.

Cooling unit 104, blower 106 and motor 108 may be mounted on a stand 120 or on floor.

Delivery conduit 116 includes an anti-static conduit 124, a conduit 126, a conduit 128, a conduit 130, a conduit 132, a conduit 134, a conduit 136 and a conduit 138.

As a non-limiting example, conduits 126, 128, 130, 132, 134, 136 and 138 may be constructed of aluminum, stainless steel, Acrylonitrile-Butadiene-Styrene also known as ABS pipe in environments that do not exceed 180 degrees Fahrenheit, or any other suitable material capable of handling the environment in which the paint drying system is installed.

A first end of anti-static conduit 124 connects to a blower outlet 140 of blower 106 and a second end connects to first end of conduit 126. The conduits should be anti-static to mitigate the possibility of static electricity in the enclosure to prevent particles from clinging to the freshly prepared surface. Second end of conduit 126 connects to first connection of a wye 144 via a fitting 142. Second connection of wye 144 connects to first end of conduit 128 via a fitting 146. Second end of conduit 128 connects to first connection of a wye 148. Conduit 130 connects to second connection of wye 144. First end of conduit 132 connects to third connection of wye 148. Third connection of wye 144 connects to first end of conduit 134 via a fitting 150. Second end of conduit 134 connects to first connection of a wye 152. Second connection of wye 152 connects to first end of conduit 136. Third connection of wye 152 connects to first end of conduit 138.

As a non-limiting example, wye 144 may be located near the midpoint of the ceiling for enclosure 102. Furthermore, as an example, wye 148 and wye 152 may be located near the centerline of enclosure 102 and near opposite ends of enclosure 102.

As a non-limiting example, fittings 142, 146 and 150 may be configured as a High Temperature Silicon Fitting (HTSF) with metal bands. Furthermore, as a non-limiting example, couplings may be constructed of Acrylonitrile-Butadiene-Styrene also known as ABS or stainless steel or any other material suitable for the environment in which the paint drying system is installed. Second end of conduits 130, 132, 136 and 138 connect to an anti-static conduit, with a sampling denoted as an anti-static conduit 153, and with anti-static conduit 153 entering enclosure 102 via holes located near corner areas of enclosure 102. A first end of anti-static conduit 153 connects to a second end of conduit 130. Entry of anti-static conduit 153 through hole located in enclosure 102 is sealed via a grommet 154 or may be caulked with any type of caulking sealing entry of anti-static conduit into enclosure 102. As a non-limiting example, grommet 154 may be constructed of rubber. Grommet 154 aids in maintaining the internal environment of enclosure 102 as a clean environment.

Anti-static conduit may be configured for entry into enclosure 102 via holes located near the midpoint of the sides for enclosure 102. As an example, locations for holes located near the midpoint of the sides of enclosure 102 are denoted as a location 156, a location 158 and a location 160. As a non-limiting example, holes may be configured as 2 inches to 4 inches in diameter.

Internal to enclosure 102, anti-static conduit 153 connects to first end of a conduit 162. As a non-limiting example, conduit 162 may be configured as aluminum.

Second end of conduit 162 connects to a first end of an anti-static conduit 164.

Second end of anti-static conduit 164 connects to first end of a flow control valve 166. Flow control valve 166 provides manual enablement, impediment and disablement of the flow of air traversing to flow control valve 166. Flow control valve 166 may be an adjustable valve such as, but not limited to a butterfly valve. Flow control valve 166 may have a manually adjustable operating mechanism such as, but not limited to, a lever or a rotatable knob or valve wheel.

In some embodiments, the drying system may be set up with control valves at each air knife for the convenience of operator adjustment when drying different size parts or vehicles and at different distances which requires air flow from 10 WC to 90 WC. For basic configuration of paint drying system, flow control valve 166 may be omitted.

Second end of flow control valve 166 connects to air knife 114.

Air knife 114 is configured such that it may be rotated in order to adjust the direction for the exiting flow of air.

A comb device 168 connects to air knife 114.

Comb device 168 covers air exit holes of air knife 114 for conversion of the laminar air flow to a turbulent air flow from air knife.

First end of intake conduit 118 connects to filter 112 and second end of intake conduit 118 connects to blower inlet.

Materials for conduits may be configured of non-static materials. Furthermore, conduits may or may not be anodized. Furthermore, conduits may or may not be powder coated.

In operation, air received from internal to enclosure 102 is filtered by filter 112. Air filtered by filter 112 travels to inlet of blower 106 via intake conduit 118. Blower 106 is cooled by cooling unit 104 to avoid permanent damage caused from high heat created in the plenum from the enclosure heat system (not shown). Motor 108 provides power for operation of blower 106 for receiving and transmitting air. Air transmitted by blower 106 travels to wye 144 via anti-static conduit 124 and conduit 126. Air received by wye 144 is split into two portions with a first portion traveling to wye 148 via conduit 128 and a second portion traveling to wye 152 via conduit 134. Air received by wye 148 is split into two portions with a first portion traveling to air knife 114 via conduit 130, anti-static conduit 153, anti-static conduit 164 and flow control valve 166 and with a second portion traveling to an air knife (not shown) located internal to enclosure 102 via conduit 132. Air received by wye 152 is split into two portions with a first portion traveling to an air knife (not shown) located internal to enclosure 102 via conduit 136 and with a second portion traveling to an air knife (not shown) located internal to enclosure 102 via conduit 138.

Paint drying system 100 introduces a large volume of re-circulated turbulent air directly over a painted surface located within enclosure 102. As a non-limiting example, re-circulated air is removed of contaminants larger than 10 microns. Furthermore, re-circulated air is oil-free, and warm.

Combs 168 associated with the air knives spread out the air exiting the air knives. Combs 168 comprise a small metal plate approximately ½″ in width with ½″ metal fingers that are secured in the front of the air knife portion 206 and cover a portion of the air outlet on an air knife and then leaves a portion open so the air is dispersed over a larger area. As a non-limiting example, the number of air knives may be four or more. The combs are configured to cover the exit holes for the air knives in an alternating fashion. As a non-limiting example, 50% to 90% of the exit hole of an air knife is covered by comb material and 10% to 50% of the exit hole is not covered by comb material. Preferably 50% is covered and 50% is left open. Covering half or more of the air knife causes higher air pressure, projecting the air stream farther in the enclosure and allows for a larger area to be dried to accommodate facilities that dry automobiles and those that dry buses or other large vehicles. As a non-limiting example, the metal fingers blocking airflow associated with the comb may be ½ to 5 inch in width with the opening for airflow being ½″ to 5″ in width. As a non-limiting example, the distance between the area that blocks airflow on the fingers of the comb may be ½ to 5 inches in width restricting 50% or more of the opening in the air knife. By using a larger air knife and covering more area a taller vehicle may be dried with the dryer. In a non-limiting example a typical passenger vehicle may only require 18″ of airflow using ½″ blocked and ½″ openings to allow for 9″ of airflow spread over 18″ whereas a bus or other taller vehicle may require upwards to 96″ of airflow coverage from the air knife. Using larger spacing such as ½ to 5 inch airflow opening with up to ten inches of blocked airflow would disperse air over an area of 96″ +or− enabling coverage sufficient for effectively drying larger, taller vehicles. The typical open area being ½″ and the closed or blocked area being 5″ on a 96″ air knife with combs. Comb associated with air knife disperses the airflow into a wide pattern. Flow of air exiting air knife as a result of associated comb is dispersed in a wider pattern than an air knife not configured with a comb. Furthermore, the airflow exiting air knife with associated comb results in a turbulent air flow in contrast to a laminar air flow provided by a conventional spray booth downdraft airflow. A laminar flow is one in which a fluid or gas flows in parallel layers. A turbulent flow can be characterized as chaotic with stochastic property changes. As a non-limiting example, air flow exiting air knife ranges from 10 to 90 inches WC with airflow of 70 to 2,000 CFM at 2,000 to 8,000 feet per minute with the typical setting being 4,500 feet per minute using a single centrifugal blower using re-circulated booth plenum air at temperatures up to 400 degrees which is then heated an additional 40 to 50 degrees Fahrenheit as a natural byproduct of the compression of our air in the centrifugal blower. In cases where the part is located close to the air knife such as a vehicle plastic bumper the setting may be only 2,000 to 3,000 feet per minute and when a smaller compact size vehicle is being dried at a greater distance from the air knife, the airflow may be increased to 5,000 to 8,000 feet per minute to better cover the paint surface at a greater distance especially when the operator is applying the first phases of paint such as primer with a typical setting of 55 inch WC. Furthermore, air temperature is increased as a result of the compression associated with the blower 106. As a non-limiting example, the air temperature exiting the air knifes of paint drying system 100 may be increased 40 to 50 degrees Fahrenheit as a result of the compression associated with blower 106. In a non-limiting example, a single stage centrifugal blower generates air pressures of from about 0.5 pounds per square inch to about 10.0 pounds per square inch. The mechanical force of compressing the air molecules produces a heat rise over the air temperature of ambient air at the inlet to the blower of about twenty-five degrees Fahrenheit for each pound per square inch of blower pressure. Furthermore, increased temperature is achieved without incurring additional utility costs. In some embodiments, paint drying system 100 may be used on powder coating ovens with temperatures typically operating in the range of 320 to 400 degrees Fahrenheit to move air at a higher velocity to accelerate the process.

The configuration of paint drying system 100 results in an observation of a reduction in the relative humidity of the spray booth enclosure by 40 to 50%.

As a non-limiting example, the airflow for paint drying system 100 may be configured for 2,000 to 8,000 feet per minute. The typical setting being 4,500 feet per minute.

The use of re-circulated air and comb devices for creating a turbulent air flow results in decreased time for drying paint and also results in improved efficiency and lower cost. As a non-limiting example, the time for drying waterborne paints is decreased with an improvement in efficiency and reduction in cost.

Paint drying system 100 decreases drying time, rapidly and evenly increases metal temperature and creates a harder finish for processed items as compared to conventional systems. Non-limiting examples of finishes include waterborne paints, primers and clear coats. As a non-limiting example, paint drying system 100 may be used for the automotive industry as well as for other industrial paint processing applications. As a non-limiting example, paint drying system 100 may be used for drying urethane, epoxy, polyester, alkyd, melamine, latex, lacquer, acrylic, glue, and sealant.

Paint drying system 100 may be used to convert a conventional laminar flow system to a system using a centrifugal blower for re-circulating heated air from the upper section of the enclosure commonly referred to as the plenum. As a non-limiting example, paint drying system 100 uses aluminum ducting, high grade filter, flow control valves, a multiplicity of air knives and combs attached to air knives. Flow control valves operate to control the flow of air to the item being processed by paint drying system 100. A multiplicity of air knives provide a flow of air with associated comb devices diffusing the flow of air in a turbulent manner.

FIG. 1 illustrates a paint drying system incorporating re-circulated air and air knives with associated comb devices for converting the laminar flow of the air knives to a turbulent flow for realizing decreased drying time and cost and increased efficiency over conventional systems.

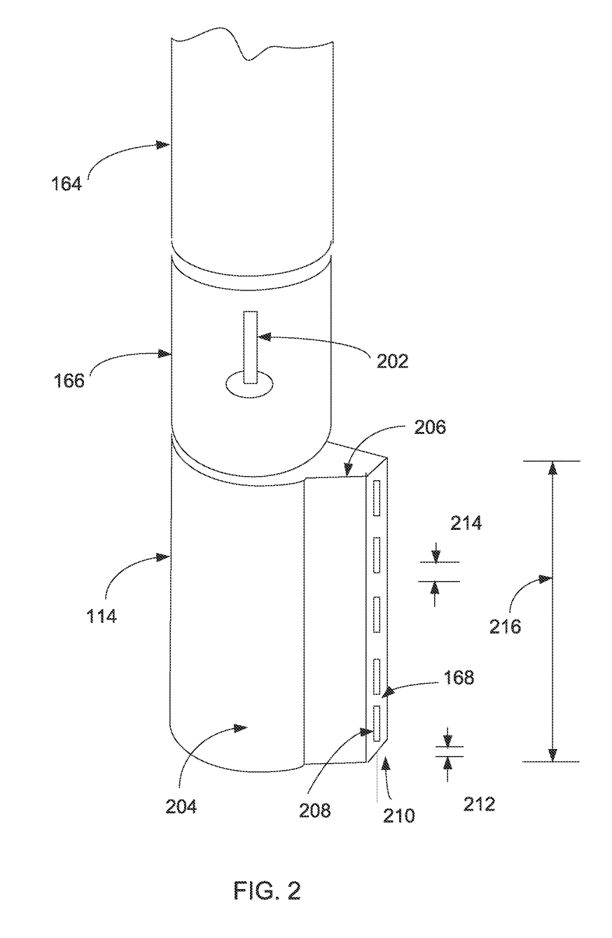

FIG. 2 illustrates a close-up view of an example air-knife as described with reference to FIG. 1, in accordance with an embodiment of the present invention.

Anti-static conduit 164 receives flow of air from delivery system and provides flow of air to flow control valve 166. Flow control valve 166 receives flow of air and may deliver, not deliver or partially deliver received air flow to air knife 114. Configuration for the amount of air flow associated with flow control valve 166 is manually controlled via a handle 202.

Air knife 114 includes a conduit portion 204, a knife portion 206, and a multiplicity of combs with a sampling denoted as comb device 168.

As a non-limiting example, a length 216 for air knife 114 may range from 3 inches to 96 inches. The larger air knives may be used when drying a taller vehicle such as a bus drying in an enclosure or a wall when used in a commercial drying application. In an alternative embodiment, the aluminum delivery conduit including wyes and elbows may be replaced with Acrylonitrile-Butadiene-Styrene (ABS) pipe and fittings when supply or outlet air temperature does not exceed 180 degrees Fahrenheit. This saves money on materials and time in the assembly process.

In operation, air knife 114 receives air flow from flow control valve 166. Conduit portion 204 receives air flow and directs air flow to knife portion 206. Knife portion 206 receives air flow from conduit portion 204 and delivers air flow along its length.

The comb 168 comprises a plurality of holes 208 that disrupts the laminar air flow from knife portion 206. As a non-limiting example, comb 168 may be configured as metal.

The narrowing of knife portion 206 increases the velocity for the flow of air as provided by hole 208. Furthermore, separating holes by non-hole portions increases the velocity for the flow of air as provided by hole 208.

Comb openings or holes 208 may range in size from 0.5″ to 5″. Comb closed areas, blocking the flow of air from knife portion 206 may range in size from 1.2″ to 5″. Typical holes 208 may be rectangular in shape. In other embodiments, holes 208 may comprise other geometric shapes, such as, but not limited to, round, oval, square, etc.

In operation, closed areas of comb 168 spread air flow exiting from hole 208 over a larger area. Air is pulled into the air stream from the back of the air knife's tear drop shape creating a turbulent air flow.

Direction of air flow exiting air knife 114 may be modified by rotation of air knife 114.

Air knives with combs broaden the range of expelled air and operate to diffuse expelled air.

Combs break up the flow of expelled air from holes and enable configuring for a larger air knife without sacrificing air pressure. As a non-limiting example, nine inches of hole opening may be used for an eighteen inch air knife. Furthermore, as a non-limiting example, a range of hole opening may be configured from three inches to ninety-six inches. Preferably eighteen inches in an enclosure.

Combs increase the turbulence of the expelled air from the holes and inhibit creation of a boundary layer about an item (not shown) located within enclosure 102 (FIG. 1). A drying process is performed for item while located within enclosure 102 (FIG. 1). For a conventional process with a laminar flow, the laminar flow makes for increased drying time associated with waterborne paint. However, the turbulent flow, generated as a result of the combs, enables quick drying of waterborne paint.

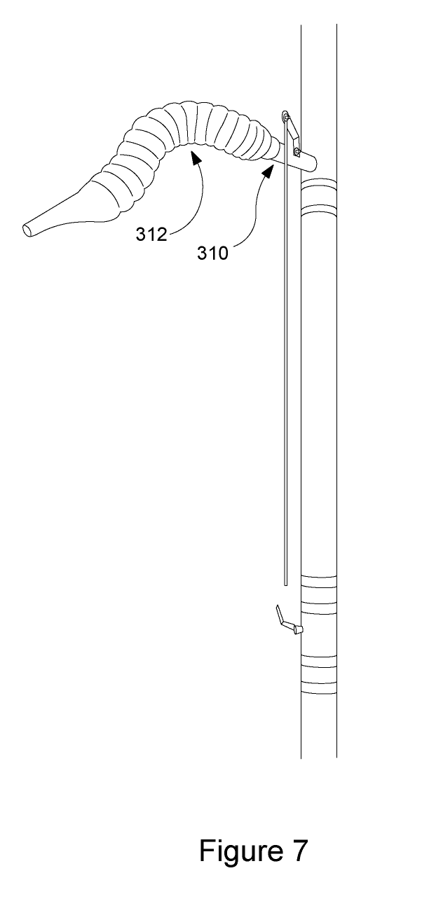

Referring to FIG. 7, a directional air nozzle on a flexible hose 312 with a shutoff valve 310 may be added at the 4-7 foot elevation in one or more corners of the enclosure and may be adjusted by the operator to allow for consistent drying times of vehicle roof tops. The preferable elevation would be 6 feet from floor elevation. As a non-limiting example, a ½″ to 1½″ full port brass valve may be located at any location in the enclosure with a 1″ to 2″ hose reel.

FIG. 2 illustrates an air knife with an associated comb device where comb device operates to convert laminar air flow exiting air knife to a turbulent air flow for realizing decreased drying time and cost and increased efficiency over conventional systems. As air flows through the duct and out of the tear shaped air knife, it pulls air into the air stream from the sides of the knife and creates turbulence as the air is propelled forward into the enclosure.

FIG. 3 presents a picture of an example air knife configuration as described with reference to FIGS. 1-2, in accordance with an embodiment of the present invention.

Presented in FIG. 3 are grommet 154 (FIG. 1), anti-static conduit 153 (FIG. 1), conduit 162 (FIG. 1), anti-static conduit 164 (FIG. 1), flow control valve 166 (FIG. 1), handle 202 (FIG. 2), air knife 114 (FIG. 1), knife portion 206 (FIG. 2), comb 168 (FIG. 2), and hole 208 (FIG. 2).

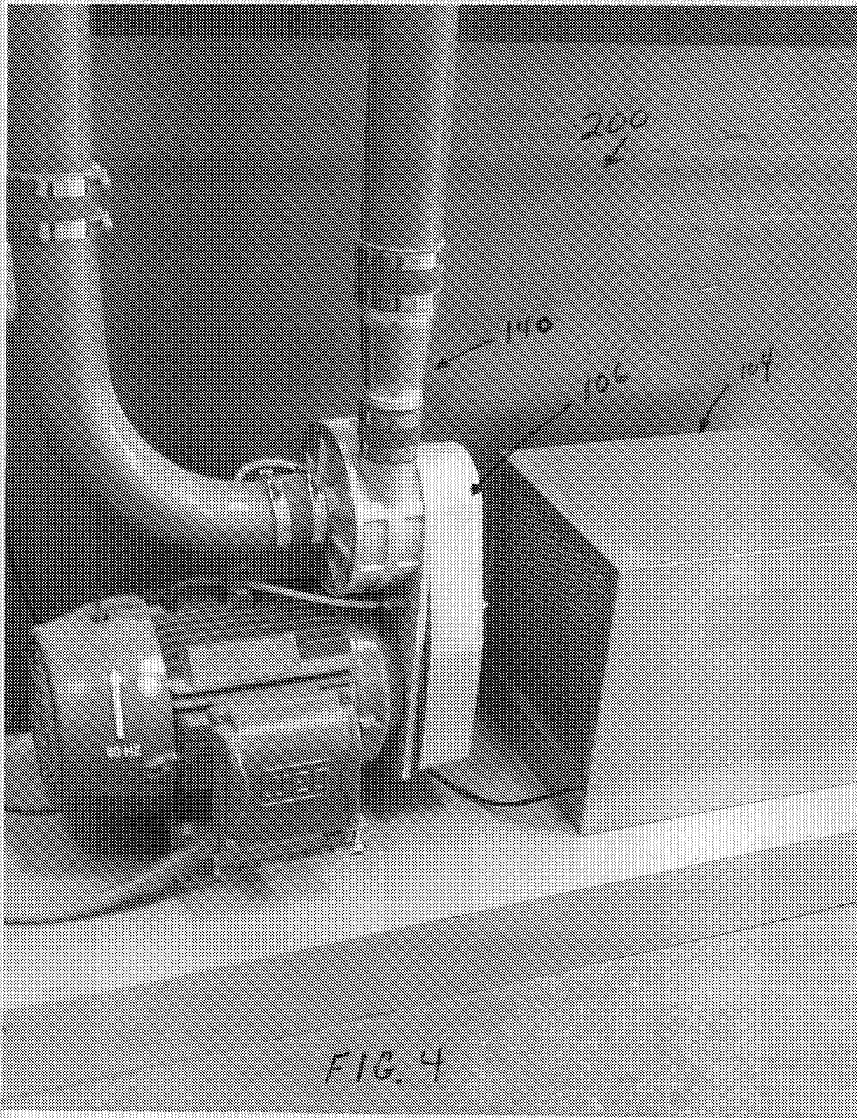

FIG. 4 presents a picture of an example of a single enclosure air delivery assembly as described with reference to FIGS. 1-2, in accordance with an embodiment of the present invention. Presented in FIG. 4 are cooling unit 104 (FIG. 1), blower 106 (FIG. 1) and motor 108 (FIG. 1).

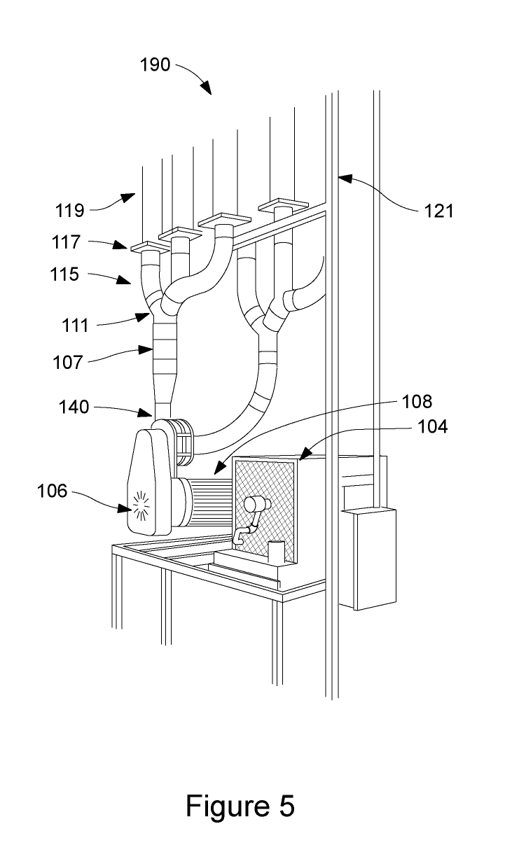

FIG. 5 presents a picture of an example of the multiple booth air delivery assembly as described with reference to FIGS. 1-2, in accordance with an embodiment of the present invention. Presented in FIG. 5 are cooling unit 104 (FIG. 1), blower 106 (FIG. 1) motor 108 (FIG. 1), blower outlet 140, control valve 107, wye 111, multiple conduits 115, multiple pneumatic slide gate valves 117 and multiple conduits for inlet and outlet air to multiple booths (booths not shown).

FIG. 6 presents a picture of a programmable logic relay. FIG. 6 presents a typical programmable logic relay 301 for a control unit that when programmed may operate at least motor 108 and cooling unit 104 in accordance with embodiments of the present invention.

FIG. 7 presents a picture of a flexible arm with shutoff valve. FIG. 7 presents flexible arm 312 and shutoff valve 310.

Paint drying system 100 (FIG. 1) employs re-circulation of air delivered to air knives with associated comb devices. Comb device combined with an air knife operate to convert laminar flow exiting air knife to a turbulent air flow. Turbulent air flow results in decreased drying time and cost and increased efficiency over conventional systems. Paint drying system 100 (FIG. 1) uses a high volume, low pressure flow of air through an air knife with associated comb devices for realizing a harder paint finish in a decreased amount of time as compared to conventional systems.

Industry representatives report having not observed paint drying as fast and hard as observed while using paint drying system 100 (FIG. 1). The fast drying time as observed for paint drying system 100 (FIG. 1) enables processed items to proceed to other stages of a painting process sooner and thereby realizing decreased costs and increased efficiency. Industry representatives also report the ability to immediately transfer a freshly painted vehicle from spray booth enclosure to the buffing department while conventional drying processes can take 60 minutes or longer. Furthermore, due to the increased performance of paint drying system 100 (FIG. 1), re-work efforts may be significantly reduced thereby realizing an additional decrease in associated costs. This automated system of drying enables the operator to begin preparing the next vehicle after applying paint allowing for further labor savings. In an insurance based collision center, cycle times (the time it takes to process a customer vehicle from start to finish) are crucial. Using the paint drying system 100 (FIG. 1) an operator can speed production by 50% or more because of faster drying times.

In some embodiments of the present invention, the air outlet is configured with an air knife with combs. In other embodiments of the present invention ½″ to 1½″ nozzles may be used instead. A nozzle configuration may consist of nozzles located at various locations throughout the booth with the typical locations being mounted on the wall directly next to the entry door and directly in front and the rear of the vehicle to be painted. In some other embodiments, a manifold may be configured to mount on the wall or in the corner of the booth with nozzles spaced 10″ to 12″ apart.

In another embodiment, as a non-limiting example, the paint drying system 100 (FIG. 1) may be used to move air from one end of a large industrial oven used to bake epoxy type coatings where air temperatures can vary from one end of the booth to the other as much as 20 to 30 degrees in a cross draft booth with vinyl curtains on one or more sides or any environment that requires consistent air temperatures. By installing the paint drying system 100 (FIG. 1) and insulating the delivery conduit, the air temperature may remain the same from one end to the other. This allows the operator to introduce high temperature turbulent air flow to any place needed for accelerating drying of any type of coating.

In another embodiment, as a non-limiting example, the paint drying system 100 (FIG. 1) may be used to direct air flow onto thicker metals such as those used in commercial and industrial applications so that when epoxy primers and epoxy paints are applied the cure time is reduced from a typical 8 to 24 hours down to 4 hours or less. As an example, an aliphatic polyurethane topcoat specification state that it will take 24 hours to cure if metal temperature is 50 degrees, 8 hours if 70 degrees and only 4 hours at 90 degrees. Heavy, thick metals used in the industrial market can remain at room temperature of the main building at which they were stored for long periods of time when transferred to the oven because of such low air volume in a typical enclosure or oven. By using the paint drying system 100 (FIG. 1) and applying high volume, heated air directly onto the metal surface thereby raising metal temperature before applying the topcoat will save anywhere from 16 to 20 hours of cure time in the enclosure thus allowing for an increase in production from one spray booth enclosure or oven of up to 600%.

In another embodiment as a non-limiting example, the paint drying system 100 (FIG. 1) may be used to raise metal temperature for any finish prior to application to shorten flash off times and speed drying by achieving higher, even metal temperatures at a much faster rate than possible with any standard spray booth enclosure. This enables an operator to increase production and lower utility costs because of less time needed in the heated booth enclosure.

In another embodiment as a non-limiting example, the paint drying system may incorporate the use of a 1½″ full port brass valve branching off of the conduit in order to supply air supply to an air hose that allows the operator to blow off the item to be painted. This further insures that debris will not blow loose during drying. Furthermore, as a non-limiting example, ionization may be used to remove any potential static charge the item may have prior to painting. Static electricity can cause many problems such as dust attraction and fisheyes in the paint. As a non-limiting example, a retractable hose reel as available may be mounted anywhere in the booth to allow the operator to retract the hose once blow off is complete.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of paint drying systems according to the present invention will be apparent to those skilled in the art. The invention has been described above by way of illustration, and the specific embodiments disclosed are not intended to limit the invention to the particular forms disclosed. For example, the particular implementation of the air knife and associated comb device may vary depending upon the particular type of item being processed. The air knife and comb device described in the foregoing were directed to automotive implementations; however, similar techniques for woodworking implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
a blower comprising an inlet and an outlet, said blower being operable for moving a volume of air from said inlet to said outlet;
a motor being operable for controlling said blower to move the air;
a cooling unit being operable for cooling bearings of said blower during operation of said blower;
an intake conduit being joined to said inlet, said intake conduit being configured for passing heated air from a plenum space atop of a paint spray booth enclosure;
delivery conduit being joined to said outlet, said delivery conduit being configured for delivering the heated air to a plurality of locations within the paint spray booth enclosure;
a plurality of air knifes being joined to said delivery conduit at the plurality of locations, each of said plurality of air knifes being operable for delivering a laminar flow of the heated air into the paint spray booth; and
a plurality of comb devices, each being joined to a one of said plurality of air knifes, each of said plurality of comb devices being configured to disrupt the laminar flow to produce a turbulent flow in which an object within the paint spray booth enclosure is surrounded by the turbulent flow of heated air.

2. The system as recited in claim 1, in which said comb device comprises a plurality of structures operative for forming alternate openings and blockings of the laminar flow to produce the turbulent flow.

3. The system as recited in claim 2, in which said openings are rectangular in shape.

4. The system as recited in claim 1, further comprising a plurality of control valves joining said plurality of air knifes to said delivery conduit for regulating flows of the heated air.

5. The system as recited in claim 1, further comprising a control unit for activating said motor and said cooling unit at programmed intervals.

6. The system as recited in claim 1, further comprising at least one positionable hose device being joined to said delivery conduit at a location within the paint spray booth enclosure for directing an additional flow of heated air at the object.

7. The system as recited in claim 6, further comprising an additional control valve joining said at least one positionable hose device to said delivery conduit for regulating the additional flow of heated air.

8. The system as recited in claim 1, further comprising a filter being joined to said intake conduit for filtering the heated air from the plenum space.

9. The system as recited in claim 1, further comprising: an intake manifold being joined to said inlet and a plurality of intake conduits, said intake manifold being configured for passing heated air from a plurality of plenum spaces atop of a plurality of paint spray booth enclosures; and a delivery manifold being joined to said outlet and a plurality of delivery conduits, said delivery conduits being configured for delivering the heated air to a plurality of locations within a plurality of paint spray booth enclosures.

10. The system as recited in claim 9, further comprising a plurality of delivery control valves joining said manifold to said plurality of deliver conduits, said plurality of control valves being operative for regulating the flow of the heated air to said plurality of delivery conduits.

11. A system comprising:
means for moving a volume of air from an inlet to an outlet;
means for controlling said moving means to move the air;
means for cooling bearings of said moving means during operation of said moving means;
means for passing heated air from a plenum space atop of a paint spray booth enclosure to said inlet;
means for filtering the heated air from the plenum space;
means for delivering the heated air from said outlet to a plurality of locations within the paint spray booth enclosure;
means for regulating flows of the heated air at the locations;
means being joined to said regulating means for releasing a laminar flow of the heated air into the paint spray booth; and
means being joined to said releasing means for disrupting the laminar flow to produce a turbulent flow in which an object within the paint spray booth enclosure is surrounded by the turbulent flow of heated air.

12. The system as recited in claim 11, further comprising means for activating said controlling means and said cooling means at programmed intervals.

13. The system as recited in claim 11, further comprising: means for directing an additional flow of heated air at the object; and means for regulating the additional flow of heated air.

14. The system as recited in claim 11, further comprising: means for passing heated air from a plurality of plenum spaces atop of a plurality of paint spray booth enclosures to said inlet; and means for delivering the heated air to a plurality of locations within a plurality of paint spray booth enclosures.

15. The system as recited in claim 14, further comprising means for regulating the flow of the heated air to the plurality of paint spray booth enclosures.

16. A system comprising:
a blower comprising an inlet and an outlet, said blower being operable for moving a volume of air from said inlet to said outlet;
a motor being operable for controlling said blower to move the air;
a cooling unit being operable for cooling bearings of said blower during operation of said blower;
an intake conduit being joined to said inlet, said intake conduit being configured for passing heated air from a plenum space atop of a paint spray booth enclosure;
a filter being joined to said intake conduit for filtering the heated air from the plenum space;
delivery conduit being joined to said outlet, said delivery conduit being configured for delivering the heated air to a plurality of locations within the paint spray booth enclosure;
a plurality of control valves being joined to said delivery conduit at the plurality of locations for regulating flows of the heated air;
a plurality of air knifes each being joined to a one of said plurality of control valves, each of said plurality of air knifes being operable for delivering a laminar flow of the heated air into the paint spray booth; and
a plurality of comb devices, each being joined to a one of said plurality of air knifes, each of said plurality of comb devices comprising a plurality of structures operative for forming alternate rectangular openings and blockings of the laminar flow, said plurality of structures being configured to disrupt the laminar flow to produce a turbulent flow in which an object within the paint spray booth enclosure is surrounded by the turbulent flow of heated air.

17. The system as recited in claim 16, further comprising a control unit for activating said motor and said cooling unit at programmed intervals.

18. The system as recited in claim 16, further comprising: at least one positionable hose device being joined to said deliver conduit at a location within the paint spray booth enclosure for directing an additional flow of heated air at the object; and an additional control valve joining said at least one positionable hose device to said delivery conduit for regulating the additional flow of heated air.

19. The system as recited in claim 16, further comprising: an intake manifold being joined to said inlet and a plurality of intake conduits, said intake manifold being configured for passing heated air from a plurality of plenum spaces atop of a plurality of paint spray booth enclosures; and a delivery manifold being joined to said outlet and a plurality of delivery conduits, said delivery conduits being configured for delivering the heated air to a plurality of locations within a plurality of paint spray booth enclosures.

20. The system as recited in claim 19, further comprising a plurality of delivery control valves joining said manifold to said plurality of deliver conduits, said plurality of control valves being operative for regulating the flow of the heated air to said plurality of delivery conduits.
